(19) United States
(12) Patent Application Publication
(10) Pub. No.: US 2006/0268169 A1
(43) Pub. Date: Nov. 30, 2006

(54) Method for video processing, video processor, video processing system and control method thereof

(75) Inventor: Jea-hee Han, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/353,198

(22) Filed: Feb. 14, 2006

(30) Foreign Application Priority Data
May 24, 2005 (KR) 2005-0043744

(51) Int. Cl. H04N 7/01

(52) U.S. Cl. 348/458

(57) ABSTRACT

Provided is a method for video processing that comprises down-converting an inputted High Definition (HD) video signal into a Standard Definition (SD) video signal and up-converting the down-converted video signal into a HD video signal that is outputted. Further provided is a method for video processing, a video processor, a video processing system and control a method thereof varying a resolution of an inputted HD video signal, thereby enhancing a video quality of a video signal having an original source resolution that is a SD resolution.

### CROSS-REFERENCE TO RELATED APPLICATIONS

This application claims the benefit under 35 U.S.C. §119(a) of Korean Patent Application No. 2005-0043744, filed on May 24, 2005, in the Korean Intellectual Property Office, the entire disclosure of which is hereby incorporated by reference.

### BACKGROUND OF THE INVENTION

1. Field of the Invention

The present invention relates to a method for video processing, a video processor, a video processing system and a control method thereof. More particularly, the present invention relates to a method for video processing, a video processor, a video processing system and a control method thereof processing a HD (High Definition) video signal by converting the HD video signal's resolution.

2. Description of the Related Art

Advances in semiconductor, computer and communication technologies have led to enhancements in audio and video compression technologies. These audio and video compression technologies have been introduced to broadcast systems are responsible for the rapid shift from analog broadcast systems to digital broadcast systems.

The video signals of digital broadcast systems are classified based on their resolution into either SD (Standard Definition) or HD. At the present time, differing countries have adopted either SD signals or HD signals in accordance to their broadcast policies.

HD signals are capable of producing a much higher video quality compared to SD signals. The difference in quality is enough for users to distinctly discriminate between the video quality of HD signals and SD signals.

However, the original source signal for broadcast HD signal can be either a HD-signal or an up-converted SD signal.

When an HD-signal that is an up-converted SD-signal is displayed on a large-sized Liquid Crystal Display (LCD) panel or Plasma Display Panel (PDP), the resulting video quality is poor.

For example, when transmitting a television drama filmed in SD (such as 480i), that has been up-converted into HD (1080i), the resulting video displayed on a display panel that is 40-inch or more may have visible scanning lines.

Accordingly, there is a need for an improved method for video processing, an video processor, an video processing system and a control method that can display HD signals that are up-converted SD-signals on displays without compromising picture quality.

### SUMMARY OF THE INVENTION

An aspect of the present invention is to address at least the above problems and/or disadvantages and to provide at least the advantages described below. Accordingly, an aspect of the present invention is to provide a method for video processing, a video processor, a video processing system and control a method thereof varying resolution of an inputted HD-format video signal, thereby enhancing an video quality of an video signal of which an original source resolution is an SD-format.

The foregoing and/or other aspects of the present invention are achieved by providing a method for video processing comprising down-converting an inputted High Definition (HD) video signal into a Standard Definition (SD) video signal; and up-converting the down-converted video signal into a HD video signal that is outputted, in accordance with exemplary embodiments of the present invention.

According to an exemplary embodiment of the present invention, the method for video processing further comprises determining a source resolution of the inputted HD video signal, wherein down-converting is performed when the source resolution is determined to be a SD resolution.

According to an exemplary embodiment of the present invention, the method for video processing further comprises de-interlacing the SD video signal, wherein up-converting the down-converted video signal comprises up-converting the de-interlaced SD video signal into the outputted HD video signal.

According to an exemplary embodiment of the present invention, a vertical resolution of the SD video signal is substantially 540i, a vertical resolution of the de-interlaced SD video signal is substantially 540p, and a vertical resolution of the outputted HD signal is substantially 720p.

According to an exemplary embodiment of the present invention, the method for video processing further comprises converting the outputted HD video signal into a video signal having a resolution associated with a display panel.

According to an exemplary embodiment of the present invention, down-converting is performed when a user selects a resolution-change mode.

The foregoing and/or other aspects of the embodiments of the present invention are also achieved by providing an video processor comprising a down-converter for down-converting an inputted High Definition (HD) video signal into a Standard Definition (SD) video signal; and an up-converter for up-converting the down-converted video signal into a HD video signal that is outputted, in accordance with exemplary embodiments of the present invention.

According to an exemplary embodiment of the present invention, the video processor further comprises a source resolution signal-determinator for determining a source resolution of the inputted HD video signal and outputting a respective control signal when the source resolution is determined to be a SD resolution, wherein the down converter down-converts the inputted HD video signal into a SD video signal according to the control signal of the source resolution signal determinator.

According to an exemplary embodiment of the present invention, the video processor further comprises a de-interlacer for de-interlacing the SD video signal, wherein the up converter up-converts the de-interlaced SD video signal to into the outputted HD video signal.

According to an exemplary embodiment of the present invention, the video processor further comprises a display and an output processor for converting the outputted HD video signal into a video signal having a resolution associated with the display and for outputting to the display the video signal having a resolution associated with the display.

According to an exemplary embodiment of the present invention, the video processor further comprises a user-interface for enabling a user to select a resolution-change mode and a microcomputer for outputting a control signal according to the user selected resolution-change mode, wherein the down converter down-converts the inputted HD video signal into the SD video signal according to the control signal output from the microcomputer.

The foregoing and/or other aspects of the embodiments of the present invention are also achieved by providing a control method of a video processing system comprising a video source comprising a Standard Definition (SD) video signal that is converted into a High Definition (HD) video signal and/or a video source comprising an original HD video signal, wherein the converted HD video signal and/or the original HD video signal are transmitted as a transmitted HD video signal; and a video processor processing the transmitted HD video signal, comprising: generating information on a source resolution of the transmitted HD video signal prior to the transmitted HD video signal being transmitted; transmitting the transmitted HD video signal to the video processor and the information on the source resolution of the transmitted HD video signal; determining, by the video processor, the source resolution of the transmitted HD video signal based on the transmitted information on the source resolution of the transmitted HD video signal; down-converting the transmitted HD video signal into a SD video signal when the source resolution of the transmitted HD video signal is a SD resolution, based on the determination; and processing the transmitted HD video signal down-converted into the SD video signal and up-converting it into an output HD video signal, in accordance with exemplary embodiments of the present invention.

According to an exemplary embodiment of the present invention, the control method of the video processing system further comprises de-interlacing the SD video signal, wherein the up-converting up-converts the de-interlaced SD video signal into the output HE video signal.

According to an exemplary embodiment of the present invention, the control method of the video processing system further comprises converting the output HD video signal into a video signal having a resolution associated with a display panel.

The foregoing and/or other aspects of the embodiments of the present invention are achieved by providing a video processing system comprising a Standard Definition (SD) video source comprising a SD video signal that is converted into a High Definition (HD) video signal and/or a HD video source comprising an original HD video signal, wherein the converted HD video signal and/or the original HD video signal are transmitted as a transmitted HD video signal; and a video processor processing the transmitted HD video signal, comprising: a transmitter for transmitting the transmitted HD video signal, an up-converter for converting the SD video signal of the SD video source into the HD format, and an information generator for generating information on a source resolution of the transmitted HD video signal prior to the transmitted HD video signal being transmitted and transmitting it along with the transmitted HD video signal through the transmitter; and the video processor comprising a receiver which receives the transmitted HD video signal, a source resolution signal-determinator determining the source resolution of the received transmitted HD video signal and outputting a respective control signal when the source resolution is a SD resolution, a down converter down-converting the transmitted HD video signal into in a SD video signal according to the control signal of the signal-determinator, and an up converter processing transmitted HD video signal down-converted into the SD video signal and up-converting it into a output HD video signal, in accordance with exemplary embodiments of the present invention.

According to an exemplary embodiment of the embodiments of the present invention, the video processor further comprises a de-interlacer for de-interlacing the SD video signal, wherein the up converter up-converts the de-interlaced SD video signal to into the outputted HD video signal.

According to an exemplary embodiment of the present invention, the video processor further comprises a display and an output processor for converting the outputted HD video signal into a video signal having a resolution associated with the display and for outputting to the display the video signal having a resolution associated with the display.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a control block diagram to illustrate an video processing system comprising a TV according to a first embodiment of the present invention;

FIG. 2 is a control flow chart to illustrate a method for video processing of the TV and a control method of the video processing system according to the first embodiment of the present invention;

FIG. 3 is a control block diagram of a TV according to a second embodiment of the present invention; and

FIG. 4 is a control flow chart of the TV according to the second embodiment of the present invention.

Throughout the drawings, the same drawing reference numerals will be understood to refer to the same elements, features, and structures.

### DETAILED DESCRIPTION OF THE PREFERRED EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

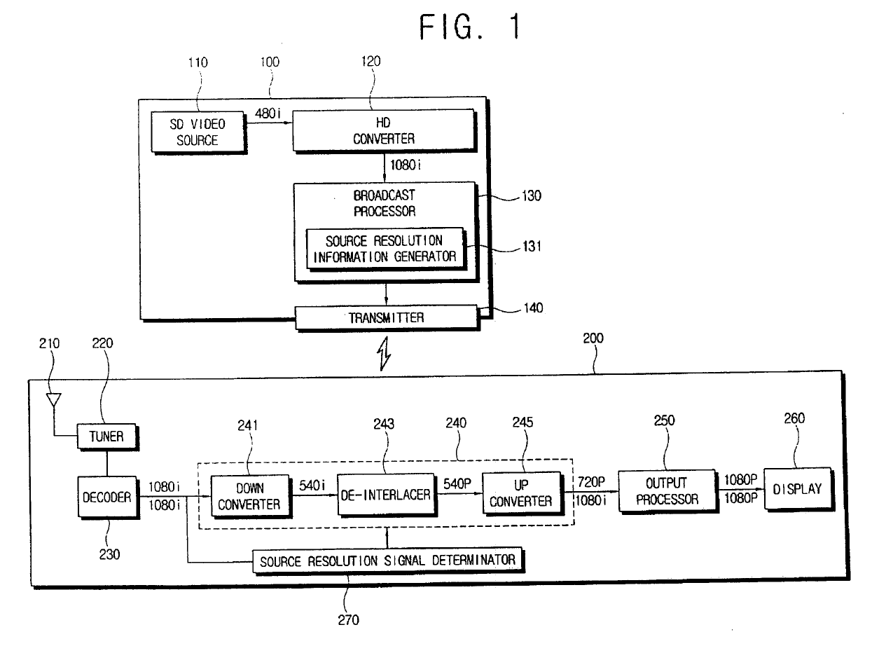

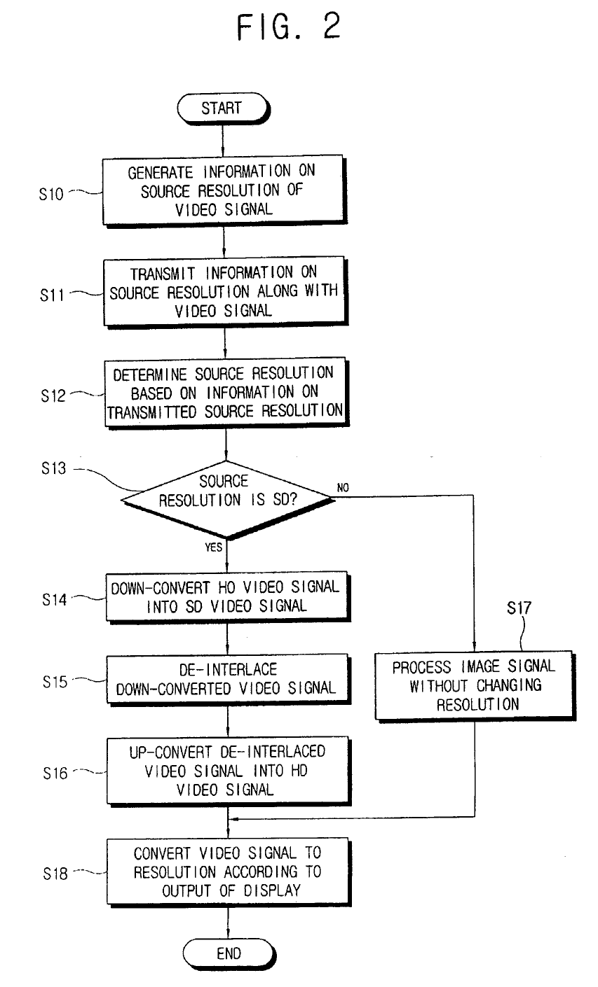

A TV 200 and a video processing system according to a first embodiment of the present invention will be described with referring to FIGS. 1 and 2.

The video processing system comprises a broadcast system 100 transmitting a broadcast signal, and the TV 200 receiving the broadcast signal transmitted from the broadcast system 100 and displaying video associated with the broadcast signal.

The broadcast system 100 comprises a Standard Definition (SD) video source 110 comprising a SD video signal, a High Definition (HD) converter up-converting a SD video signal into an HD-SD video signal, a broadcast processor 130 processing the HD-SD video signal and producing a HD broadcast signal, and a transmitter 140. Here a HD-SD video signal is a HD video signal that was created by up-converting a SD video signal. A HD video signal is a video signal that was originally created as a HD video signal. When a vertical resolution of the SD video signal from the SD video source 110 is 480 interlanced lines (480i), the HD converter 120 converts it into 1080 interlanced lines (1080i). Meanwhile, a HD video signal from a HD video source (not shown) is inputted to the broadcast processor 130 without passing though the HD converter 120. A HD video signal from a HD video source that is inputted to the broadcast processor 130 is processed by broadcast processor 130 and the broadcast processor 130 produces a HD broadcast signal. Thus, either a HD-SD video signal or a HD video signal is input to broadcast processor 130 as a HD input video signal, with broadcast processor 130 producing a HD broadcast signal for either.

The broadcast processor 130 comprises a source coder and a compressor (not shown), a multiplex and a transmission path encoder (not shown), and an RF transmitter (not shown). The source coder and the compressor decrease the bit rate of the HD video input signal and compress the digital data stream of the HD video input signal. Next, the multiplexer and transmission path encoder divide the video signal into packets comprising the digital data stream. Further, the multiplexer and the transmission path encoder characteristically prescribes each packet or packet type and multiplexes the packets of the data stream. The video signal then goes through a channel encoding and a modulation process at the RF transmitter.

The broadcast processor 130 comprises a source resolution information generator 131 generating information on the original source resolution of the HD video input signal. The information on the original source resolution may be comprised in a specific data field of a video data stream or of an auxiliary data stream.

The broadcast system 100 then transmits in the HD broadcast signal information indicating the original source resolution of the HD video input signal along with the HD video input signal.

The TV 200 according to the first embodiment of the present invention comprises an antenna 210 receiving the HD broadcast signal; a tuner 220 tuning the HD broadcast signal to a user selected channel; a decoder 230 decoding the tuned HD broadcast signal and outputting it as the decoded HD video signal, the sound signal or data; and an video processor 240 and an output processor 250 which process the decoded HD video signal and display 260. Here, the HD broadcast signal received from the broadcast station has a vertical resolution of 1080i in accordance with digital broadcast standards.

The video processor 240 processes the decoded HD video signal with one of two processing modes according to a control signal from a source resolution-determinator 270. The video processor 240 outputs a processed video signal to output processor 250 which performs a final video processing. Here, a first mode of the two processing modes functions to output a processed video signal based on the decoded HD video signal but having a changed resolution (resolution-change mode), and second mode functions to output a processed video signal based on the decoded HD video signal without having a changed resolution.

Video processor 240 comprises a down converter 241 for down-converting the resolution of the decoded HD video signal into the SD signal, a de-interlacer 243 for converting the down-converted video signal into a progressive scan signal, and an up converter 245 for converting the resolution of the progressive scan signal into a HD signal.

Preferably, video processor 240 may be realized by a chipset comprising a scaler for processing the decoded HD video signal, de-interlacer 243, a controller, a memory and other components.

The down converter 241 down-converts the vertical resolution of a 1080i decoded HD video signal into a 540 interlaced lines (540i) SD video signal. The down converter 241 may be realized by the scaler.

The de-interlacer 243 converts the vertical resolution of the 540i video signal into a 540 progressive scan lines (540p) video signal and may be realized by an Interlace-Progressive-Converter (IPC).

In a de-interlacing method of the IPC, there may be a two dimensional (2D) method using an intrafield processing method and a three dimensional (3D) method using an interfield processing method. Furthermore, a motion-adaptive method and/or a motion compensated method may be used. The motion-adaptive method uses the 3D method when there is little movement in the video signal and the 2D method when there is a lot of movement in the video signal. The motion compensated method calculates to process a motion vector between successive fields by sampling.

The up converter 245 up-converts the 540p video signal to a 720 progressive scan lines (720p) video signal, which is one of the digital broadcast standards, and may be realized by the scaler.

The source resolution-determinator 270 extracts information on the source resolution of the decoded HD video signal and determines whether the original source resolution is SD or HD, thereby outputting an appropriate control signal. Preferably, the source resolution-determinator 270 may be realized by a controller chip such as a microcomputer or microprocessor. The signal-determinator 270 may be provided separately from the video processor 240 in the TV 200 according to the first embodiment of the present invention. Alternatively, signal-determinator 270 may be realized by the controller comprised in the chipset of the video processor 240.

The output processor 250 processes the outputted processed video signal from the video processor 240 by converting it into a suitable vertical frequency, resolution, a portion of a screen or the like according to a capability of the display 260 and may be realized by the chipset comprising the de-interlacer and scaler.

The output processor 250 according to the first embodiment of the present invention converts 1080i and 720p video signals into 1080p video signals. A 1080i video signal is inputted to output processor 250 from the video processor 240 when the video processor 240 is not operating in resolution-change mode and a 720p video signal is inputted when the video processor 240 is in a resolution-change mode. Those video signals are respectively converted into a 1080p video signal by the output processor 250. Here, the output processor 250 may minimize deterioration of the signal, which may occur while processing, by adjusting a 2D and 3D threshold according to the resolution of the video signal while converting the video signal to 1080p.

The display 260 displays the video signal output from output processor 250 on a screen of a display panel. The display 260 comprises a display panel on which video is displayed and a panel driver. The display panel may comprise a Liquid Crystal Display (LCD), Plasma Display Panel (PDP) or any other type of display.

FIG. 2 is a control flow chart illustrating a method for video processing and a control method of the video processing system according to the first embodiment of the present invention.

As shown in FIG. 2, the source resolution information generator 131 generates information on whether the original source resolution of the HD broadcast video signal is HD or SD, at operation S10.

The information on the source resolution is added to a data field and transmitted along with the HD broadcast video signal, at operation S11. The vertical resolution of the transmitted HD broadcast video signal is 1080i.

The HD broadcast video signal received through the antenna 210 of the TV 200 is tuned via tuner 220 to a user selected channel, decoded and outputted by decoder 230. Thereby, the source resolution signal-determinator 270 extracts the information on the source resolution and determines the original source resolution of the decoded HD video signal, at operation S12.

When the source resolution is determined to be SD, at operation S13, the source resolution signal-determinator 270 applies an appropriate control signal to the video processor 240 and the down converter 241 down-converts the vertical resolution of the inputted decoded HD video signal from 1080i to 540i, at operation S14.

The down-converted video signal is converted to 540p and outputted by de-interlacer 243, at operation S15, and the converted video signal is up-converted to 720p and outputted by up converter 245, at operation S16.

When the source resolution signal determinator 270 determines the source resolution to be SD, it controls the video processor 240 so as to convert the vertical resolution from 1080i to 720p.

When the source resolution signal-determinator 270 determines the source resolution to be HD, it controls the video processor 240 so as to process the signal without converting the resolution, at operation S17.

The output processor 250 converts a 1080i or 720p video signal inputted from the video processor 240, to a 1080p suitable for the display 260, at operation S18.

Therefore, the video signal is processed differently depending on the original source resolution of the HD broadcast video, thereby realizing better displayed video quality when the original source resolution is SD.

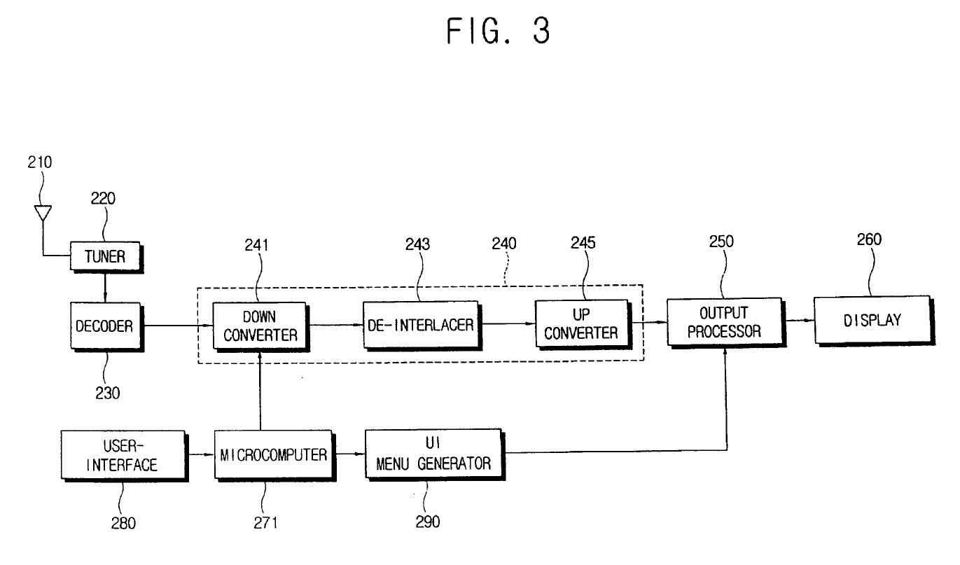

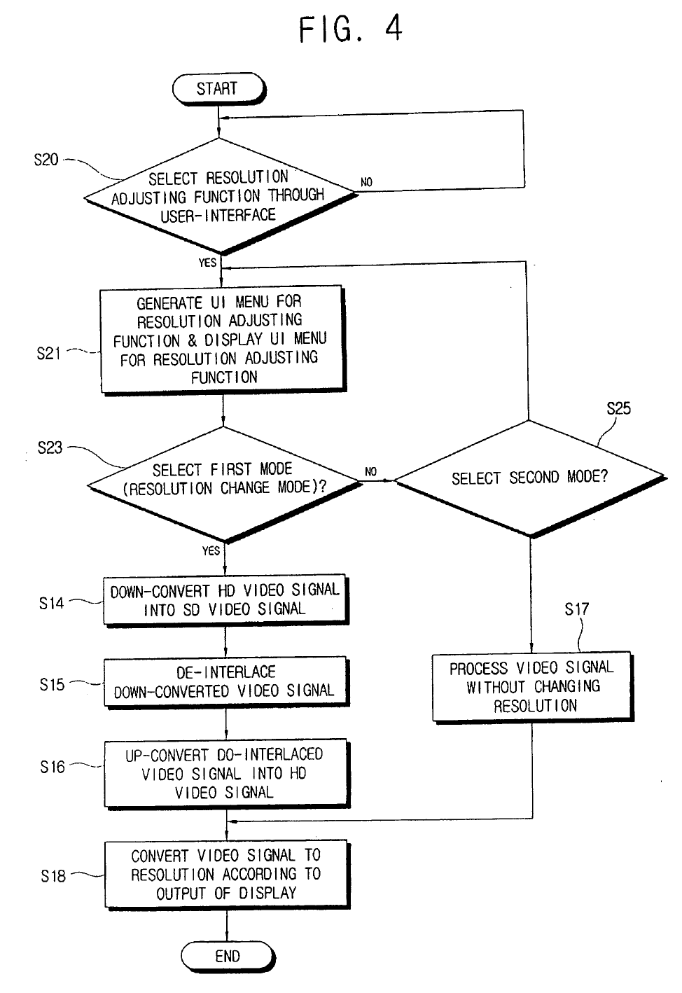

Next, a TV 200 and a method for video processing of the TV according to a second embodiment of the present invention will be described with referring to FIGS. 3 and 4.

As shown in FIG. 3, the TV 200 according to the second embodiment of the present invention comprises a tuner 220, a decoder 230, a video processor 240, an output processor 250, a display 260, a user-interface 280, a user interface (UI) menu generator 290 and a microcomputer 271.

The video processor 240 comprises a first mode (resolution-change mode) converting the resolution of a decoded video signal and processing it, and a second mode processing the video signal without converting the resolution.

The user-interface 280, which is an interface comprising keys to receive input from a user, outputs a key signal to the microcomputer 271 according to the user's manipulation of the keys on the interface. The user-interface 280 comprises a menu key to select a resolution-adjusting function, a handling key to indicate or select UI items displayed on a screen and a key signal generator generating a key signal corresponding to manipulation of the keys by the user. Further, the user-interface 280 may be an input device separately connected, such as a mouse, a keyboard or a wireless remote controller.

The UI menu generator 290 generates a menu for the resolution-adjusting function according to the control of the microcomputer 271. The menu generated by the UI menu generator 290 comprises at least one resolution-change mode. The UI menu generated by the UI menu generator 290 according to the second embodiment of the present invention comprises a first mode (resolution-change mode) with which the video processor 240 converts a 1080i video signal to a 720p video signal and a second mode of processing without changing the video signal's resolution.

Further, the UI menu may comprise a mode converting the vertical resolution to a resolution other than 1080i or 720p.

The microcomputer 271 controls the UI menu generator 290 to generate the menu and display it according to a key-control signal of the user-interface 280 and the video processor 240 to operate according to the selected mode through the user-interface 280. In the second embodiment, the microcomputer 271 is provided separately from the video processor 240, but may be comprised in the video processor 240.

FIG. 4 is a control flow chart of the TV according to the second embodiment of the present invention.

When a user selects the resolution adjusting function through the user-interface 280, at operation S20, the key control signal is inputted to the microcomputer 271 and controls the UI menu generator 290 to generate the UI menu for the resolution adjusting function and displays it on the display 260, at operation S21.

Here, the user indicates or selects the UI items displayed on the display 260 through the user-interface 280. When the user selects the first mode (resolution-change mode), at operation S23, the microcomputer 271 applies the control signal so that the video processor 240 processes the 1080i video signal to a 720p video signal.

That is, the down converter 241 of the video processor 240 down-converts the 1080i decoded HD video signal to 540i, at operation S14. The de-interlacer 243 converts the down-converted video signal to 540p, at operation S15 and the up converter 245 up-converts the 540p video signal to 720p, at operation S16.

When the user selects the second mode through the user-interface 280, at operation S25, the video processor processes the decoded HD video signal without changing the resolution, at operation S17.

Further, the 1080i or 720p video signal output from the video processor 240 is converted to 1080p and outputted to display 260 by the output processor 250, at operation S18.

Therefore, when the user is not satisfied with the video quality, he/she selects the resolution-change mode by hand so that the video processor 240 converts the resolution, thereby providing better video quality.

In the other embodiment of the present invention, the above-mentioned video processor 40 is not decisively operated in the first mode and the second mode by selection of the source resolution signal-determinator 270 and the user-interface 280, but may be operated by only the first mode (resolution-change mode). Further, it is described as an example that the video signal is inputted and processed to specific resolution, which is not limited, in the above-mentioned embodiments.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for video processing comprising:
down-converting an inputted High Definition (HD) video signal into a Standard Definition (SD) video signal; and
up-converting the down-converted video signal into a HD video signal that is outputted.

2. The method for video processing according to claim 1, further comprising determining a source resolution of the inputted HD video signal, wherein down-converting is performed when the source resolution is determined to be a SD resolution.

3. The method for video processing according to claim 2, further comprising de-interlacing the SD video signal, wherein up-converting the down-converted video signal comprises up-converting the de-interlaced SD video signal into the outputted HD video signal.

4. The method for video processing according to claim 3, wherein a vertical resolution of the SD video signal is substantially 540i, a vertical resolution of the de-interlaced SD video signal is substantially 540p, and a vertical resolution of the outputted HD signal is substantially 720p.

5. The method for video processing according to claim 2, further comprising converting the outputted HD video signal into a video signal having a resolution associated with a display panel.

6. The method for video processing according to claim 1, wherein down-converting is performed when a user selects a resolution-change mode.

7. The method for video processing according to claim 6, further comprising de-interlacing the SD video signal, wherein up-converting the down-converted video signal comprises up-converting the de-interlaced SD video signal into a HD video signal.

8. The method for video processing according to claim 7, wherein a vertical resolution of the SD video signal is substantially 540i, a vertical resolution of the de-interlaced SD video signal is substantially 540p, and a vertical resolution of the outputted HD signal is substantially 720p.

9. The method for video processing according to claim 6, further comprising converting the outputted HD video signal to a resolution associated with a display panel.

10. A video processor comprising:
a down-converter for down-converting an inputted High Definition (HD) video signal into a Standard Definition (SD) video signal; and
an up-converter for up-converting the down-converted video signal into a HD video signal that is outputted.

11. The video processor according to claim 10, further comprising a source resolution signal-determinator for determining a source resolution of the inputted HD video signal and outputting a respective control signal when the source resolution is determined to be a SD resolution, wherein the down converter down-converts the inputted HD video signal into a SD video signal according to the control signal of the source resolution signal determinator.

12. The video processor according to claim 11, further comprising a de-interlacer for de-interlacing the SD video signal, wherein the up converter up-converts the de-interlaced SD video signal to into the outputted HD video signal.

13. The video processor according to claim 11, further comprising a display and an output processor for converting the outputted HD video signal into a video signal having a resolution associated with the display and for outputting to the display the video signal having a resolution associated with the display.

14. The video processor according to claim 10, further comprising a user-interface for enabling a user to select a resolution-change mode and a microcomputer for outputting a control signal according to the user selected resolution-change mode, wherein the down converter down-converts the inputted HD video signal into the SD video signal according to the control signal output from the microcomputer.

15. The video processor according to claim 14, further comprising a de-interlacer for de-interlacing the SD video signal, wherein the up converter up-converts the de-interlaced SD video signal to into the outputted HD video signal.

16. The video processor according to claim 14, further comprising a display and an output processor for converting the outputted HD video signal into a video signal having a resolution associated with the display and for outputting to the display the video signal having a resolution associated with the display.

17. A control method of a video processing system comprising a video source comprising a Standard Definition (SD) video signal that is converted into a High Definition (HD) video signal and/or a video source comprising an original HD video signal, wherein the converted HD video signal and/or the original HD video signal are transmitted as a transmitted HD video signal; and a video processor processing the transmitted HD video signal, comprising:
generating information on a source resolution of the transmitted HD video signal prior to the transmitted HD video signal being transmitted;
transmitting the transmitted HD video signal to the video processor and the information on the source resolution of the transmitted HD video signal;
determining, by the video processor, the source resolution of the transmitted HD video signal based on the transmitted information on the source resolution of the transmitted HD video signal;
down-converting the transmitted HD video signal into a SD video signal when the source resolution of the transmitted HD video signal is a SD resolution, based on the determination; and
processing the transmitted HD video signal down-converted into the SD video signal and up-converting it into an output HD video signal.

18. The control method of the video processing system according to claim 17, further comprising de-interlacing the SD video signal, wherein the up-converting up-converts the de-interlaced SD video signal into the output HD video signal.

19. The control method of the video processing system according to claim 18, further comprising converting the output HD video signal into a video signal having a resolution associated with a display panel.

20. A video processing system comprising a Standard Definition (SD) video source comprising a SD video signal that is converted into a High Definition (HD) video signal and/or a HD video source comprising an original HD video signal, wherein the converted HD video signal and/or the original HD video signal are transmitted as a transmitted HD video signal; and a video processor processing the transmitted HD video signal, comprising:
a transmitter for transmitting the transmitted HD video signal, an up-converter for converting the SD video signal of the SD video source into the HD format, and an information generator for generating information on a source resolution of the transmitted HD video signal prior to the transmitted HD video signal being transmitted and transmitting it along with the transmitted HD video signal through the transmitter; and
the video processor comprising a receiver which receives the transmitted HD video signal, a source resolution signal-determinator determining the source resolution of the received transmitted HD video signal and outputting a respective control signal when the source resolution is a SD resolution, a down converter down-converting the transmitted HD video signal into in a SD video signal according to the control signal of the signal-determinator, and an up converter processing transmitted HD video signal down-converted into the SD video signal and up-converting it into a output HD video signal.

21. The video processing system according to claim 20, wherein the video processor further comprises a de-interlacer for de-interlacing the SD video signal, wherein the up converter up-converts the de-interlaced SD video signal to into the outputted HD video signal.

22. The video processing system according to claim 20, the video processor further comprises a display and an output processor for converting the outputted HD video signal into a video signal having a resolution associated with the display and for outputting to the display the video signal having a resolution associated with the display.
